(19) United States
(12) Patent Application Publication
(10) Pub. No.: US 2025/0126520 A1
(43) Pub. Date: Apr. 17, 2025

(54) ON-DEMAND WIRELESS LINK BETWEEN ACCESS POINTS

(71) Applicant: Ruckus IP Holdings LLC, Claremont, NC (US)

(72) Inventors: Saravanan Mohandass, Erode (IN); Siva Lingaprasad Sola, Bangalore (IN); Mani Dinesh, Bangalore (IN)

(21) Appl. No.: 18/775,067

(22) Filed: Jul. 17, 2024

(30) Foreign Application Priority Data
Oct. 17, 2023 (IN) 202341070760

(51) Int. Cl. H04W 28/086; H04W 76/10; H04W 84/12

(52) U.S. Cl. CPC H04W 28/086; H04W 76/10; H04W 84/12

(57) ABSTRACT

A system may include a plurality of access points, each configured to communicate with one or more client devices; and a monitoring engine configured to receive metric data periodically from the plurality of access points and further configured to generate confidence score profiles for each of the plurality of access points. A first access point of the plurality of access points is configured to: receive a set of confidence score profiles from the monitoring engine; detect occurrence of a dynamic wireless link creation event; select, in response to the detecting of the occurrence of the dynamic wireless link creation event and based on the confidence score profiles, a second neighbor access point; establish a dynamic wireless link between the first access point and the second neighbor access point; and direct at least some network traffic to the second neighbor access point using the established dynamic wireless link.

### CROSS-REFERENCE TO RELATED APPLICATION

The present application claims the benefit of priority to Indian Patent Application number 202341070760, filed Oct. 17, 2023, the entire contents of which are incorporated by reference as if set forth herein.

### TECHNICAL FIELD

The present disclosure relates to computer networks, and in particular relates to on-demand wireless links between access points in a wireless network.

### BACKGROUND

A wireless local area network (“WLAN”) refers to a network that operates in a limited area (e.g., within a home, school, store, campus, shopping mall, etc.) that interconnects two or more electronic devices using wireless radio frequency (“RF”) communications. Electronic devices belonging to users (“clients”) of a WLAN, such as smartphones, computers, tablets, printers, appliances, televisions, lab equipment and the like (herein “client devices”), can communicate with each other and with external networks such as the Internet over the WLAN. Since wireless communications are used, portable client devices can be moved throughout the area covered by the WLAN and remain connected to the network. Most WLANs operate under a family of standards promulgated by the Institute of Electrical and Electronics Engineers (IEEE) that are referred to as the IEEE 802.11 standards. WLANs operating under the IEEE 802.11 family of standards are commonly referred to as WiFi networks. Client devices that include a networking subsystem that includes a WiFi network interface can communicate over WiFi networks.

A WiFi network includes one or more access points (also referred to as hotspots) that are typically installed at fixed locations throughout the area covered by the WiFi network. The WiFi network can include a single access point that provides coverage in a very limited area or may include tens, hundreds or even thousands of access points that provide in-building and/or outdoor coverage to a large campus or region. Client devices communicate with each other and/or with wired devices that are connected to the WiFi network through the access points. The access points may be communicate with each other and/or with one or more controllers through wired and/or wireless connections. The WiFi network typically includes one or more gateways that may be used to provide Internet access to the client devices and/or access to other external networks.

Some WiFi networks are implemented in whole or part as so-called mesh networks. A mesh network has one or more root nodes as well as a plurality of additional nodes, which are typically implemented as access points. The root node(s) may provide a wired backhaul to external networks. A root node may, for example, comprise an access point that is connected to one or more gateways via wired connections or may comprise another electronic device such as a router. In a mesh WiFi network, at least some of the access points (herein “mesh access points”) do not include a wired connection to a root node, but instead communicate with one or more root nodes via wireless connections through other access points. Thus, a “source” mesh access point will transmit uplink mesh backhaul communications to a root node through one or more intervening access points, and the root node will transmit downlink mesh backhaul communications through one or more intervening access points to each “destination” mesh access point. Mesh WiFi networks typically self-configure to automatically select the communications path(s) used for each uplink and downlink wireless backhaul communication. For the non-root access points of a mesh network, backhaul refers to single-hop or multi-hop communications between a non-root access point and a root node that are associated with communications between the non-root access point and client devices that are associated with the non-root access point.

On the other hand, some WiFi networks are implemented as non-mesh networks. In a non-mesh network, each access point may have a dedicated wired backhaul to external networks. In other words, each access point may be connected to one or more gateways via at least one wired backhaul connection.

### BRIEF DESCRIPTION OF THE DRAWINGS

FIGS. 1A and 1B are block diagrams illustrating an example of a simplified wireless network in which problems with wired backhaul links may occur.

FIG. 2 is a block diagram of a computer network and of components thereof according to some embodiments of the present inventive concepts.

FIGS. 3A, 3B, 4, 5, and 6 are block diagrams illustrating examples of a simplified wireless network according to some embodiments of the present inventive concepts in which problems with wired backhaul links may be addressed.

FIGS. 7A and 7B illustrate communications between some devices of a computer network according to some embodiments of the present inventive concepts.

FIGS. 8A, 8B, and 9 are flow diagrams showing some operations of methods according to some embodiments of the present inventive concepts.

FIG. 10 is a block diagram of a computing device according to some embodiments of the present inventive concepts.

Like reference numerals refer to corresponding parts throughout the drawings. Moreover, multiple instances of the same part may be designated by a common prefix separated from an instance number by a dash.

### DETAILED DESCRIPTION

In both mesh network and non-mesh WiFi network arrangements, the wired backhaul links between the access points and the ‘core’ network can become saturated and/or unusable. Saturation can occur for a variety of reasons. For example, the wired backhaul link may have been originally designed to carry an initial amount of traffic, and an increase in the amount of traffic may result in the wired backhaul link unable to support the increased traffic being sent through the backhaul link, which may result in client devices competing for bandwidth.

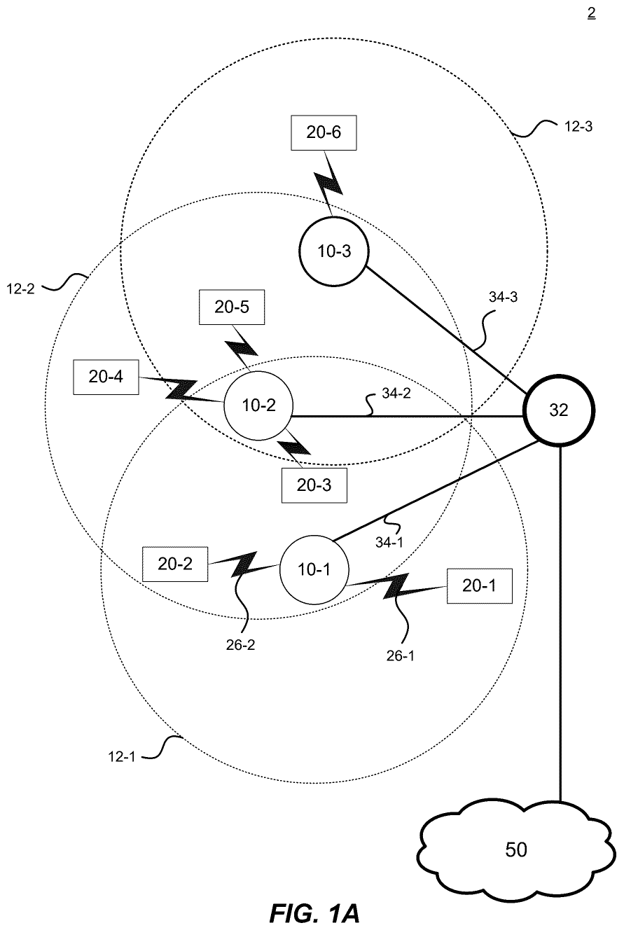

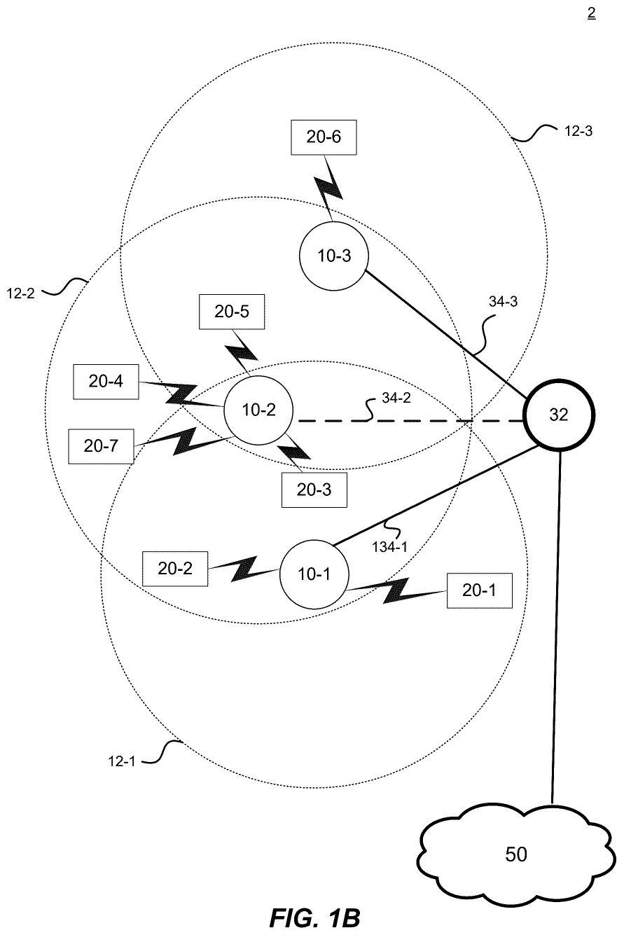

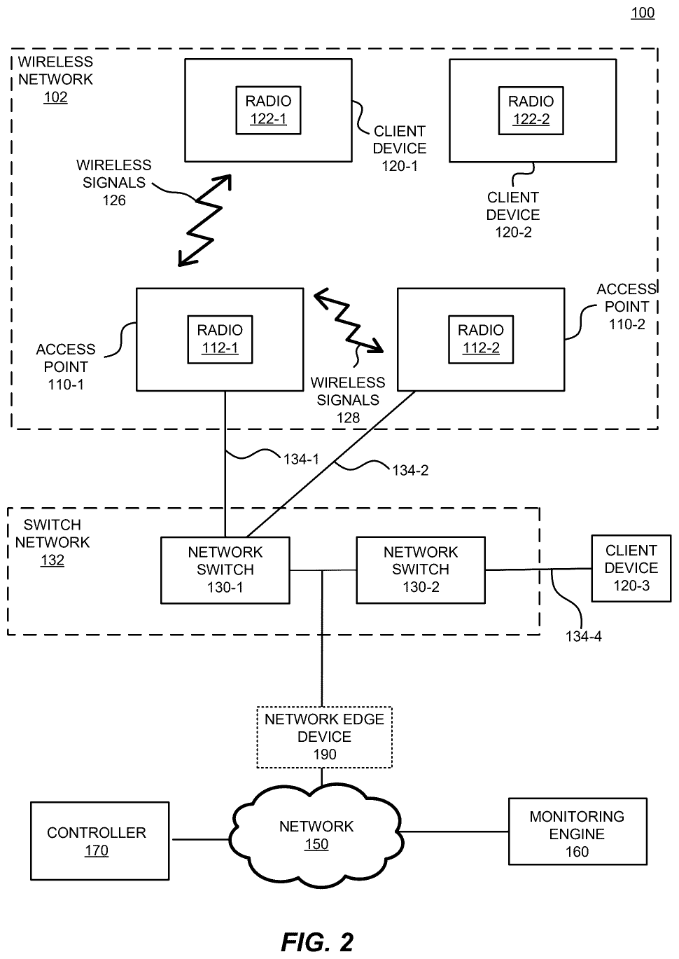

FIGS. 1A and 1B provide an example illustrating potential problems that may occur when a wired backhaul link becomes saturated. Reference is also made to FIG. 2, which is described further below, and which provides a fuller description of similarly-named components used in FIGS. 1A and 1B.

FIG. 1A shows a wireless network 2 with three wireless access points 10 (i.e., a first access point 10-1, a second access point 10-2, and a third access point 10-3). Each access point 10 has a corresponding or respective wireless coverage area 12 (i.e., the first access point 10-1 has a corresponding first wireless coverage area 12-1, and so on). Each access point 10 may be connected via a respective backhaul link 34 to a switch network 32, which may include one or more computer networking devices such as switches (e.g., access switches, core switches, distribution switches, aggregation switches, edge switches, or the like) and/or routers. The switch network 32 may provide access to a network 50. Each backhaul link 34 may include one or more physical links and/or logical links, and may include logical links that include two or more physical links, such as a link aggregation group.

Using wireless signals 26, each access point 10 may communicate with client devices 20 in the coverage area 12 of the access point 10. Each of the client devices 20 may be, for example, any network-capable electronic device, including (as non-limiting examples) a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device. Six client devices 20 (i.e., first to sixth client devices 20-1 to 20-6) are shown in FIG. 1A, with the understanding that there may be a greater or fewer number of client devices 20 in the wireless network 2.

As seen in FIG. 1B, a seventh client device 20-7 may enter the coverage area of the wireless network 2, and more particularly may enter the coverage area 12-2 of the second access point 10-2. The seventh client device 20-7 desires to associate with the wireless network 10. However, if the wired backhaul link 34-2 that provides the second access point 10-2 with a connection to the switch network 32 is at or near capacity, it may be seen that providing wireless service to this additional client device 20-7 may exceed the capacity of the wired backhaul link 34-2 between the switch network 32 and the second access point 10-2. This may result in saturation of the wired backhaul link 34-2.

When the wired backhaul link 34-2 becomes saturated, it may increase latency and/or result in reduced throughput. This is because the wired backhaul link 34-2 is no longer able to keep up with the amount of data being sent through it. The wired backhaul link 34-2 may become unable to transmit the data in a timely manner, resulting in slower speeds and longer wait times for users. This can be problematic for one or more of the client devices 20 wirelessly communicating with the second access point 10-2 and accessing the network 50, and this latency may be particularly problematic for streaming applications and other high bandwidth activities.

Some potential ways of managing the wireless network 2 to avoid congestion and/or saturation of wired backhaul links 34 are known, but insufficient. For example, a client device 20 may roam or transition to a different access point 10 in the wireless network 2. As seen in FIG. 1B, a fifth client device 20-5, which is connected to the second access point 10-2, is also in a coverage area 12-3 of the third access point 10-3. Accordingly, the fifth client device 20-5 could disconnect or disassociate from the second access point 10-2 and connect to or associate with the third access point 10-3. A decision to roam or transition to a different access point 10 in a WiFi network is typically performed by a client device 20, and the client device 20 may roam or may not roam depending on a configuration or implementation thereof. Some standards, such as basic service set (BSS) transition management (sometimes referred to as IEEE 802.11v), attempt to provide a way for the access point 10 to influence client roaming behavior by providing to the client device 20 a list of nearby or neighbor access points 10 as part of a BSS transition management message or frame. Optionally, in an effort to spur the client device 10 into performing roaming, the BSS transition management message may indicate that communicating access point 10 may perform imminent disassociation and thereby terminate the connection between the access point 10 and the client device 20. However, not all client devices 20 may implement BSS transition management standards such as IEEE 802.11v, and even when such standards are implemented by the client device 20, the client device 20 may elect not to roam to a nearby access point 10. Another shortcoming of IEEE 802.11v and other similar standards is that not all client devices 20 may be in a location to roam to a different access point 10. As seen in FIGS. 1A and 1B, the fourth client device 20-4 is only in the coverage area 12-2 of the second access point 10-2, and hence is not capable of roaming to a different access point 10.

Another potential way to address network congestion and backhaul saturation issues is through steering of a client device during the initial association process. For example, a client device 20 attempting to join the wireless network 2 through the second access point 10-2 may be instead steered to a different access point 10 (e.g., the first access point 10-1 or the third access point 10-3). Such steering may be done either by the second access point 10-2 rejecting an association request from the joining client device 20 or by the second access point 10-2 accepting the association request from the joining client device 20 and then immediately sending to the joining client device 20 a BSS transition management and disassociation imminent message similar to that discussed above. Although pre-association steering may provide some proactive capacity management, it does not address a situation such as that shown in FIG. 1B, where the seventh client device 20-7 that is attempting to join the wireless network is only in the coverage area 12-2 of the second access point 10-2 and hence not capable of associating with a different access point 10. A separate issue is that pre-association steering does not address backhaul link problems that arise from already existing client devices 20, such as burst transmissions and/or high priority data from one or more client devices 20 that result in saturation of the wired backhaul links 34.

Pursuant to some embodiments of the present inventive concepts, one or more of the above shortcomings are addressed by establishing an on-demand or dynamic wireless link between a first and second access point and then communicating, via the established on-demand wireless link, data traffic to and from client devices that are wirelessly connected to the first access point. The on-demand wireless link may be established in response to a triggering event, which may be saturation or partial or complete degradation or failure of a wired backhaul link of the first access point. The first access point may be able to establish on-demand wireless links with a plurality of access points that includes the second access point. When the triggering event is detected, the first access point may select the second access points based on a confidence score profile of the second access point. Confidence score profiles may be generated for each access point, by a monitoring engine. The monitoring engine may be configured to receive metrics from each access point in the wireless network (and/or from client devices in some embodiments) and generate the confidence score profile for each access point based on the network traffic details. In some embodiments, an on-demand or dynamic wireless link may be established in response to a first access point receiving a generated confidence score profile for the first access point that is below a threshold value.

Some examples of embodiments and scenarios pursuant to the present disclosure will now be discussed. FIG. 2 is a block diagram illustrating electronic devices and computer networking devices in a network 100 according to some embodiments of the present disclosure. In the network 100, one or more access points 110 may communicate with client devices 120 in a wireless network 102, which may be a wireless local area network (WLAN). The access points 110 may be serviced by a switch network 132 that includes one or more network switches and/or routers 130, which may facilitate access to a network (e.g., an external network) 150. The access points 110 and network switches and/or routers may be referred to herein collectively as computer networking devices 110/130. The network 100 may also include other computer networking devices (not shown) such as data planes or the like.

The access points 110 may communicate using wireless and/or wired communication (such as by using Ethernet or a communication protocol that is compatible with Ethernet) with the client devices 120. Herein, wireless communication may include communication of packets or frames in accordance with a wireless communication protocol, such as an Institute of Electrical and Electronics Engineers (IEEE) 802.11 standard (sometimes referred to as ‘WiFi’. In the discussion that follows, WiFi is used as an illustrative example. For example, an IEEE 802.11 standard may include one or more of: IEEE 802.11a, IEEE 802.11b, IEEE 802.11g, IEEE 802.11-2007. IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Other wireless interfaces and/or protocols may be used, such as Bluetooth, and unless stated otherwise, the present disclosure is not limited to a particular wireless communication standard, interface, or protocol.

In some embodiments, the access points 110 may include physical access points and/or virtual access points that are implemented in software in an environment of an electronic device or a computer. In some embodiments, the access points 110 may communicate with each other via wired or wireless connections (e.g., via the switch network 132 or via wireless signals 126). The wired and/or wireless communication among access points 110 in wireless network 102 may occur via a network (such as an intra-net, a mesh network, point-to-point connections and/or the Internet) and may use a network communication protocol, such as Ethernet. In some embodiments, the access points 110 may be arranged in a mesh configuration, such as where a direct wired or wireless connection between an access point 110 and a network switch 130 of the switch network 132 is absent, and the access point 110 instead communicates indirectly with the switch network 132 and/or the network 150 via an intermediate access point 110.

As can be seen in FIG. 2, wireless signals 126 (represented by a jagged line) may include ‘downstream’ wireless signals that are transmitted from a radio 112-1 in access point 110-1 to a radio 122-1 in a client device 120-1. The wireless signals 126 (represented by a jagged line) may include ‘upstream’ wireless signals transmitted from the radio 122-1 in the client device 120-1 to the radio 112-1 in the access point 110-1. Each of the radios 112 and 122 may be configured to generate and/or receive radio frequency signals in one or more wireless communication frequency bands (e.g., the 2.4 GHz frequency band, the 5 GHz frequency band, the 6 GHz frequency band, and so on). Although only one radio 112/122 is shown in each of the access points 110 and client devices 120, it may be understood that in some embodiments multiple radios 112/122 may be present, each configured to generate and/or receive signals in different frequency bands.

As noted above, each of the client devices 120 may be, for example, any network-capable electronic device. As seen in FIG. 2, some client devices 120 (e.g., client device 120-3) may not be part of the wireless network 102, and may instead be directly coupled with a network switch 130 of the switch network 132.

The switch network 132 may include one or more network switches and/or routers 130. In some embodiments, the one or more network switches and/or routers 130 may include a stack of multiple switches or routers (which are sometimes referred to as ‘stacking units’). As an example, a network switch 130-1 may include a number of communication interfaces or ports (not shown) in communication with one or more electronic devices. During operation, a first of the communication interfaces may receive a packet or other data container from a first electronic device (e.g., a client device 120, an access point 110, another networking switch 130). The packet may then be processed and forwarded to a second port associated with a second electronic device. The network switch and/or router 130 may be a layer-2 or layer-3 network switch or router. The switch network 132, and the network switches 130 thereof, may be coupled to at least some of the access points 110 of the wireless network 102 via wired links 134.

The controller 170 may be configured to perform configuration operations and/or management operations that control functionality of the computer networking devices 110/130. For example, the controller 170 may define flow definitions comprising packet processing rules and corresponding actions and promulgate these rules to the network switches 130 of the switch network 132. As another example, the controller 170 may manage the access points 110, for example by providing various configuration information, controlling settings, routing information, authorization/authentication information, or the like. The controller 170 may communicate with the access point 110 and/or network switches 130 via one or more logical links (not shown in FIG. 2), which in some embodiments may at least partially overlap the wired links 134. The controller 170 may be configured to offer a single user interface accessible via a web browser, command prompt, or the like, via which control commands may be entered.

In some embodiments, the controller 170 may be connected via physical links with one or more of the access points 110 or the network switches 130 (and may be part of the switch network 132). In some embodiments, the controller 170 may be one of the network switches 130. In some embodiments, the controller 170 may be a cloud-based controller 170 that may be operating at a location relatively remote from the switch network 132 and the network switches 130 thereof. The cloud-based controller 170 may communicate with the network switches 130 via a network, such as network 150.

The network 150 may be a layer-2 or layer-3 network, and may include one or more local area networks (LANs), campus area networks (CANs), wide area networks (WANs), metropolitan area networks (MANs), and/or the Internet. The network 150 may be separated from the switch network 132 by a network edge device 190, which may monitor network traffic that is incoming to and outgoing from the switch network 132 and decide whether to permit or prohibit various traffic based on one or more security rules. For example, the network edge device 190 may be or may include a firewall.

The network 100 may include a monitoring engine 160, which in some embodiments may be a separate component from the controller 170 and in some embodiments may be a component of the controller 170. The monitoring engine 160 may receive metrics from the access points 110, switches 130, and/or the client devices 120. Based on the received metrics, the monitoring engine 160 may generate a confidence score for each access point 110. The confidence score may indicate a capacity and/or link utilization of a backhaul link 134 between the access point 110 and the switch network 132. In some embodiments, the link utilization may be or may include a “towards core” link utilization, which may include a measure of the data traffic being sent from the access point 110 to a core part of the switch network 132. In some embodiments, the link utilization may be or may include a “from core” link utilization, which may include a measure of the data traffic being received by the access point 110 from the core part of the switch network 132. In some embodiments, link utilization may include one or more of throughput, packet loss, jitter and/or latency. Throughput may measure a number of packets sent and received over a given time period. Packet loss may include measurement of the number of packets that have been dropped or lost during transmission. Jitter may include a measurement of a variation in the time it takes for packets to travel from one point to the other (e.g., across backhaul link 134, within the switch network 132). Latency may include a measurement of an amount of time it takes for a packet to travel from its origin to its destination.

In some embodiments, the metrics transmitted by each access point 110 to the monitoring engine may include a length of one or more priority queues of packets or other data units to be transmitted toward the core part of the switch network by the access point 110. The length may be or may include an average length over a period of time (e.g., 5 minutes, 1 hour).

In some embodiments, the metrics transmitted from an access point 110 may include device utilization metrics, such as load (or average load over a time period) for a central processing unit of the access point 110, utilization (or average utilization over a time period) for memory of the access point 110, utilization (or average utilization over a time period) for a wireless channel or channels over which the access point 110 communicates with client devices, or the like.

In some embodiments, the metrics transmitted from an access point 110 and/or a client device 120 may include an indication of capabilities and traffic of the client devices 120 on a client device level. For example, each access point 110 may transmit metrics that include a number of client devices supporting different wireless network standards (e.g., 802.11ac, 802.11ax, 802.11n, 802.11v, and so on) that are connected to and/or associated with the access point 110. Each access point 110 may transmit per-client device metrics, such as packet error rates, data rates, and so on that are generated for each client device 120 connected to or associated with that access point 110. Each access point 110 may generate metrics that include data indicating applications (e.g., streaming applications, VoIP applications) and/or packet flows used by each client device 120 connected thereto and/or associated therewith. In some embodiments, the client devices 120 and/or switches 130 may transmit client device level metrics to the monitoring engine 160.

Based on the metrics received from the access points 110, the client devices 120, and/or the switches 130, the monitoring engine 160 may generate a confidence score profile for each access point 110. The monitoring engine 160 may periodically receive the metrics from the access points 110, the client devices 120, and/or the switches 130, and the monitoring engine 160 may periodically generate confidence score profiles for each access point 110, where the generated confidence score profiles may represent updated versions of prior confidence score profiles.

Each access point 110 may receive a set of confidence score profiles from the monitoring engine. In some embodiments the set of confidence score profiles may include a confidence score profile for itself and confidence score profiles for any neighbor access points 110 in wireless range of the access point 110 receiving the set. In some embodiments, each access point 110 may identify neighbor access points 110 based on receiving signals (e.g., beacon signals therefrom) and may communicate to the monitoring engine 160 and/or the controller 170 the neighbor access points 110 so identified.

In some embodiments, each confidence score profile will include a determination of available backhaul capacity and/or link utilization for the access point 110 corresponding thereto. In some embodiments, the determination of available backhaul capacity may be quantized or discretized into one or more levels, based on comparison of the available backhaul capacity with one or more predetermined threshold values. For example, available backhaul capacity could be discretized into “low,” “medium,” and “high” levels when compared with two or more threshold values. As another example, available backhaul capacity could be discretized into “red,” “yellow,” and “green” levels when compared with two or more threshold values. In some embodiments, the set of confidence score profiles transmitted to a first access point 110-1 may include a designation of a neighbor access point 110 that has the greatest amount of available network capacity.

In some embodiments, the confidence score profile may indicate signal (e.g., received signal strength indication (RSSI) or signal-to-noise (SNR)) for the corresponding access point 110, e.g., between the corresponding access point 110 and one or more other devices (e.g., other access points 110, client devices 120, and so on). In some embodiments, the confidence score profile may indicate an average length for one or more priority queues of the corresponding access point 110.

In some embodiments, the confidence score profile corresponding to a first access point 110-1 may indicate to a second access point 110-2 an amount of bandwidth or link capacity to be allocated or reserved for the first access point 110-1 if the first access point 110-1 requests that a dynamic wireless link be established between the first access point 110-1 and the second access point 110-2.

In some embodiments, the confidence score profile corresponding to a first access point 110-1 may indicate to a second access point 110-2 one or more high priority clients that are serviced by the first access point 110-1 and that may need high priority service by the second access point 110-2 if the first access point 110-1 requests that a dynamic wireless link be established between the first access point 110-1 and the second access point 110-2.

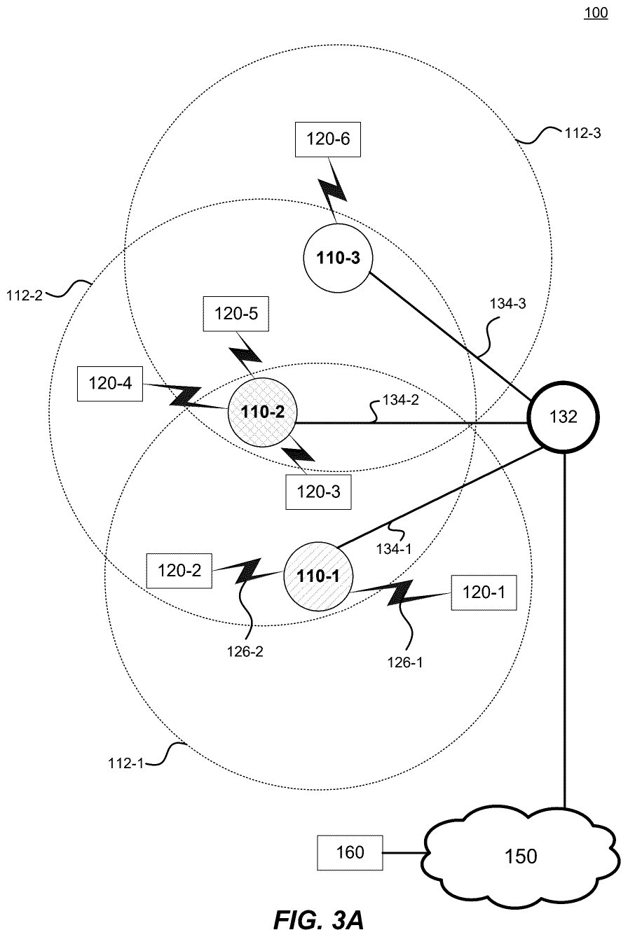

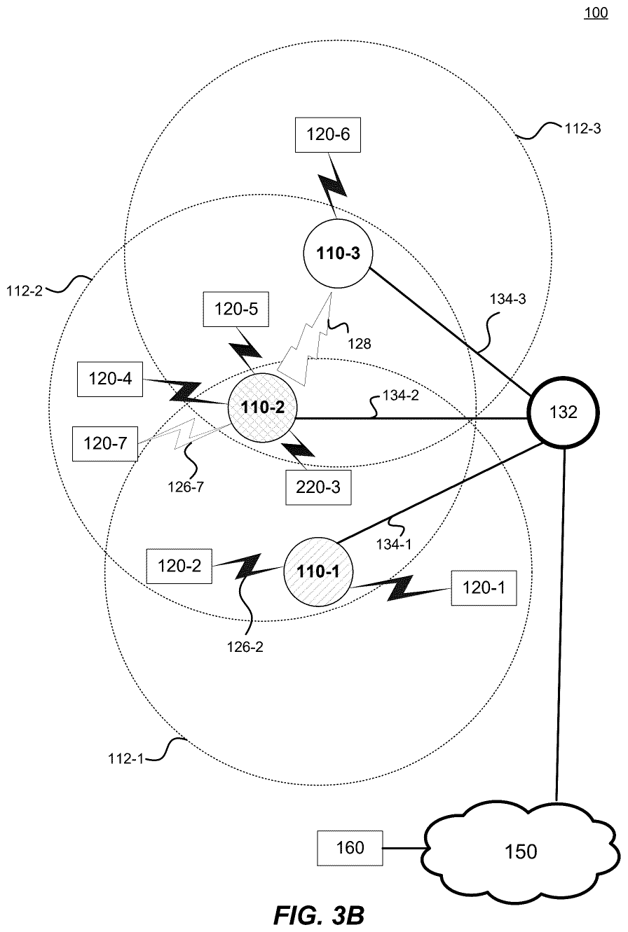

Each access point 110 may receive from the monitoring engine 160 a set of confidence score profiles respectively corresponding to other access points 110 in the wireless network 110. Subsequently, an access point (which in the examples of FIGS. 3A, 3B, 4, 5, and 6, is the second access point 110-2) may detect an event has occurred that may result in partial or complete degradation of the wired backhaul link 134 connecting the access point 110 with the switch network 132. In response to detecting the event, the access point 110 may select a neighbor access point 110 based on the set of confidence score profiles, and may transmit a request to the neighbor access point 110 that a dynamic wireless link be established between the access point 110 and the neighbor access point 110. Using the established dynamic wireless link, at least some network traffic (client traffic) may be communicated from the requesting access point 110 to the neighbor access point 110 for forwarding by the neighbor access point 110 to the switch network 132. Using the established dynamic wireless link, at least some network traffic (client traffic) may be communicated from the switch network 132 to the neighbor access point 110 for forwarding to the requesting access point 110. In some embodiments, the dynamic wireless link may be a routed connection between the requesting access point 110 and the neighbor access point 110. In some embodiments, the dynamic wireless link may be a bridged connection between the requesting access point 110 and the neighbor access point 110.

FIGS. 3A and 3B are block diagrams of a simplified wireless network illustrating a first example of problem with a wired backhaul link that may be addressed by the inventive concepts provided herein. FIG. 3A is similar to FIG. 1A, but shows that confidence score profiles have been generated by the monitoring engine 160 for each access point 110 based on a capacity or link utilization of a corresponding backhaul link 134 that connects each access point 110 to the switch network 132. In FIG. 3A, the first access point 110-1 may have a “medium” or “yellow” score, the second access point 110-2 may have a “low” or “red” score, and the third access point 110-3 may have a “high” or “green” score as indicated by the different cross-hatching in FIG. 3A.

The second access point 110-2 may receive the set of confidence score profiles, which includes a score profile for itself and for the neighbor access points 110-1 and 110-3. The “low” or “red” score for the second access point 110-2 may indicate to the second access point 110-2 that the wired backhaul link 134-2 connecting the second access point 110-2 to the switch network 132 is nearing or at saturation. This information may already be known by the second access point 110-2 or obtainable through other means.

FIG. 3B illustrates a similar event to FIG. 1B, in that a seventh client device 120-7 has entered a coverage area 112-2 of the second access point 110-2 and desires to connect with the wireless network 100. The receipt of an association request from the seventh client device 120-7 by the second access point 110-2 may be an event triggering establishment of a dynamic wireless link 128, in that attempting to provide service to the seventh client device 120-7 using the wired backhaul link 134-2 may result in partial or complete degradation of the wired backhaul link 134-2 since the link is at or near capacity.

In response to detecting the event triggering establishment of a dynamic wireless link 128, the access point 110-2 may access the set of confidence score profiles and select a neighbor access point 110 having available capacity. In the example shown in FIG. 3B, the third access point 110-3 may be selected, in large part because the capacity thereof is relatively better as compared with the first access point 110-1. In some embodiments, a score or capacity of a neighbor access point may be one of a plurality of criteria used by the second access point 110-2 to select the neighbor access point, and other criteria, such as whether the requesting access point 110-2 and neighbor access point 110-1/110-3 are in the same channel, comparative strengths of signals from neighbor access points 110-1/110-3 received by the requesting access point 110-2, comparative numbers of clients (total clients and/or high priority clients) of the neighbor access points 110-1/110-3, confidence scores of the neighbor access points 110-1/110-3, and so on. Thus, in some embodiments, the requesting access point 110-2 may select a second neighbor access point 110-3 that has less available capacity than a first neighbor access point 110-1.

In some embodiments, prior to receiving a request to establish a dynamic wireless link, a neighbor access point 110-1/110-3 may be notified through the set received from the monitoring engine 160 that a request to establish a dynamic wireless link may be expected from another access point 110-2 in the wireless network. For example, the neighbor access point 110-3 may identify that the second access point 110-2 is at or near capacity and has a “low” or “red” confidence score. In some embodiments and as discussed above, the confidence score profile for the second access point 110-2 may indicate to a neighbor access point 110-3 an amount of bandwidth or link capacity to be allocated or reserved for the second access point 110-2 if a dynamic wireless link is requested between the second access point 110-2 and the neighbor access point 110-3.

Upon receiving the request from the second access point 110-2, the third access point 110-3 may cooperate together with the second access point 110-2 to establish the dynamic wireless link 128. In some embodiments, the dynamic wireless link 128 may be or may resemble a mesh connection. In some embodiments, where the access points 110 have a plurality of radios therein, a different one of the one or more wireless communication frequency bands (e.g., the 2.4 GHz frequency band, the 5 GHz frequency band, the 6 GHz frequency band, and so on) may be used to establish the dynamic wireless link 128 than is used to communicate with the client devices 120.

Using the established dynamic wireless link 128, at least some network traffic (client traffic) may be communicated from the requesting access point 110-2 to the neighbor access point 110-3 for forwarding by the neighbor access point 110-3 to the switch network 132. At least some network traffic (client traffic) may be communicated from the switch network 132 to the neighbor access point 110-3 for forwarding to the requesting access point 110-2 via the established dynamic wireless link 128. In some embodiments, only a portion of traffic received by the access point 110-2 may be communicated via the dynamic wireless link 128. For example, only traffic from the seventh client device 120-7 may be forwarded to the switch network 132 over the dynamic wireless link 128. This may permit the backhaul link 134-2 of the second access point 110-2 to continue to serve the client devices 120 connected thereto prior to the triggering event of the seventh client device 120-7 joining the wireless network 100.

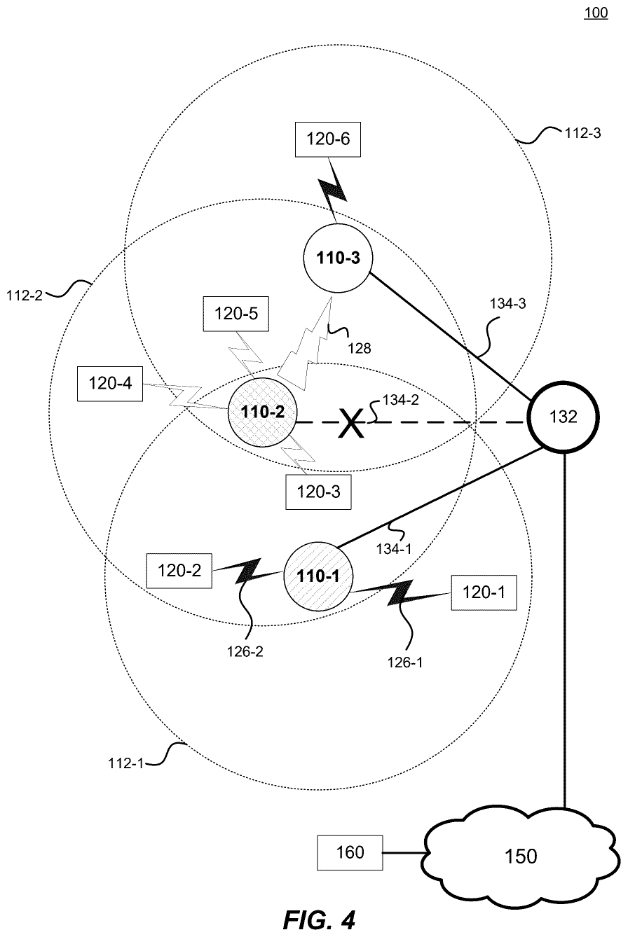

FIG. 4 is a block diagram of a simplified wireless network illustrating complete unusability of a wired backhaul link, which is a second example of a problem with a wired backhaul link that may be addressed by the inventive concepts provided herein. Unusability of a wired backhaul link (e.g., wired backhaul link 134-2 providing service to the second access point 110-2) may occur when a temporary or persistent network problem results in the wired backhaul link 134-2 being non-functional, resulting in a complete halt to a flow of network traffic between the access point 110 and the switch network 132.

Detecting, by the second access point 110-2, that the wired backhaul link 134-2 is nonfunctional and/or unusable may be an event triggering establishment of a dynamic wireless link 128. Accordingly, as seen in FIG. 4, in response to detecting that the wired backhaul link 134-2 is unusable, the second access point 110-2 may transmit a request to a selected neighbor access point 110-3 to establish a dynamic wireless link 128. The neighbor access point 110-3 may be selected based on the confidence score profile and/or other criteria as discussed above.

The requesting access point 110-2 and the neighbor access point 110-3 may cooperate to establish the dynamic wireless link 128. Once the dynamic wireless link is established, all or a portion of client traffic from the client devices 120 (e.g., third, fourth, and fifth client devices 120-3, 120-4, and 120-5) that are wirelessly communicating with the second access point 110-2 may be forwarded to the third access point 110-3 via the established dynamic wireless link 128. In some embodiments, only traffic from high priority client devices and/or high priority traffic from all client devices may be sent via the dynamic wireless link 128.

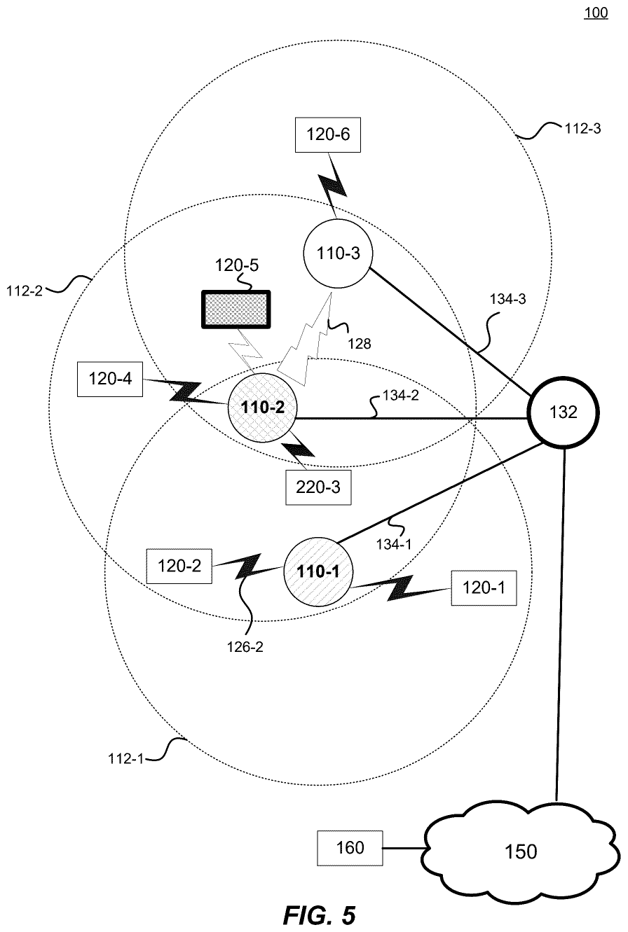

FIG. 5 is a block diagram of a simplified wireless network illustrating another potential problem with a wired backhaul link that may be addressed by the inventive concepts provided herein. One of the client devices 120 (here, the fifth client device 120-5) may want to send high priority traffic that, if sent via the wired backhaul link 134-2, may result in partial or complete degradation of the wired backhaul link 134-2 since the link is at or near capacity. In some embodiments, the client device 120-5 wanting to send high priority traffic may communicate a message to the access point 110-2 that is providing service thereto that the client device 120-5 intends to send the high priority traffic. In some embodiments, the client device 120-5 may begin to send the high priority traffic without such a message, and the servicing access point 110-2 may detect the high priority traffic (e.g., by identifying a destination of the high priority traffic, by identifying an application transmitting the high priority traffic, by examining content of the high priority traffic, or so on). An existing/already connected client device 120-5 that wants to send or is sending high priority traffic device may be an event triggering establishment of a dynamic wireless link 128. Based on detecting the client device 120-5 wants to send or is sending high priority traffic, the access point 110-2 may access the set of confidence score profiles and select a neighbor access point 110 having available capacity. The access point 110-2 may then contact the selected neighbor access point 110-3 and request that a dynamic wireless link 128 is established. In some embodiments, the dynamic wireless link 128 is established, the high priority traffic from the client device 120-5 may be communicated via the dynamic wireless link 128. In some embodiments, once the dynamic wireless link 128 is established, traffic from devices other than the client device 120-5 (which may or may not be high priority traffic) may be communicated via the dynamic wireless link 128.

In some embodiments, and with reference to FIGS. 3A, 3B, 4, and 5, once a dynamic wireless link is established, the access point 110 that requested the dynamic wireless link (and thus, the access point 110 experiencing problems with and/or reaching a capacity of a wired backhaul link 134 that is servicing the access point) may take one or more actions to limit a number of new client devices 120 connecting thereto. For example, the access point 110 may not permit new client devices 120 to connect thereto, may not permit new client devices 120 to use the established dynamic wireless link 128, may permit only traffic from high priority client devices 120 and/or high priority traffic to be communicated via the established dynamic wireless link, and so on.

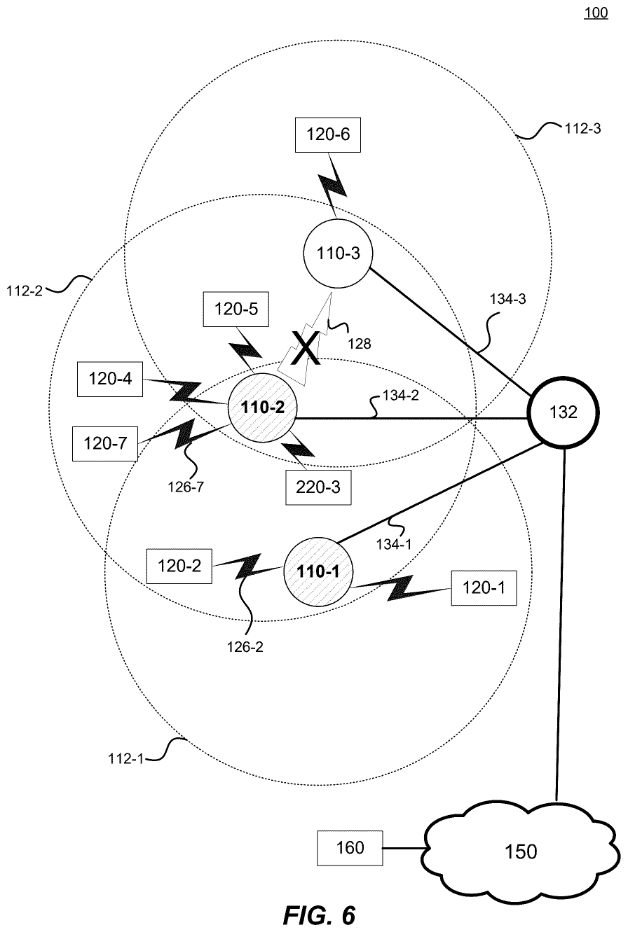

FIG. 6 is a block diagram of a simplified wireless network illustrating that at some time point subsequent to the establishing of a dynamic wireless link 128, the event or condition for which the dynamic wireless link 128 was established may no longer be present. For example, capacity or link utilization on a wired backhaul link 132 may improve (and the generated confidence score for the access point 110 may change accordingly), a wired backhaul link 132 that was previously unusable may be returned to a state of usability, or a client device may leave or may cease sending high priority traffic. The access point 110-2 may detect that the event or condition for which the dynamic wireless link 128 was established is no longer present and/or detect an event indicating that an established dynamic wireless link 128 should be torn down, resulting in the disconnection of the requesting access point 110-2 from the neighbor access point 110-3.

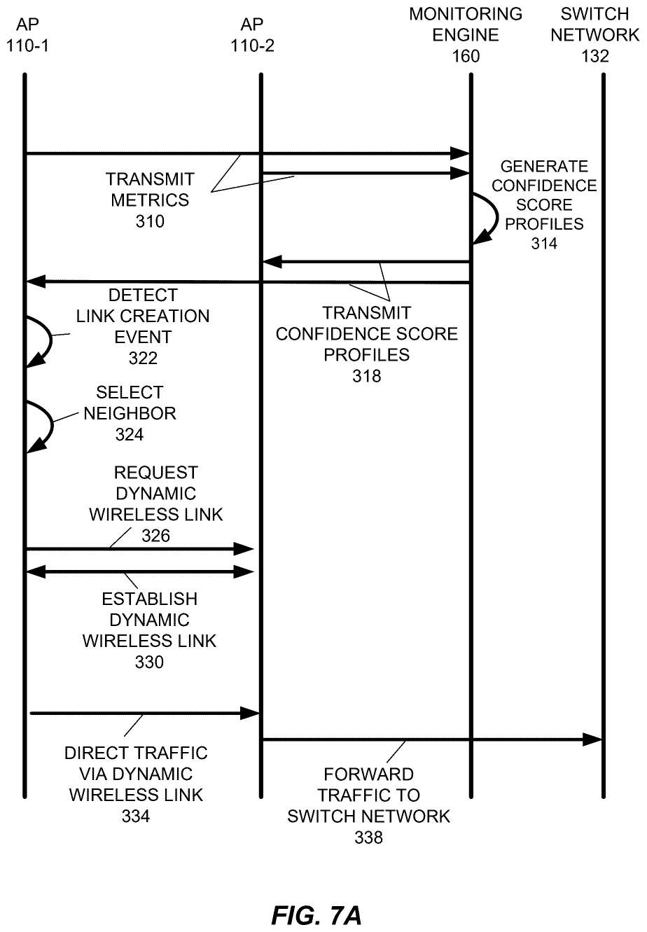

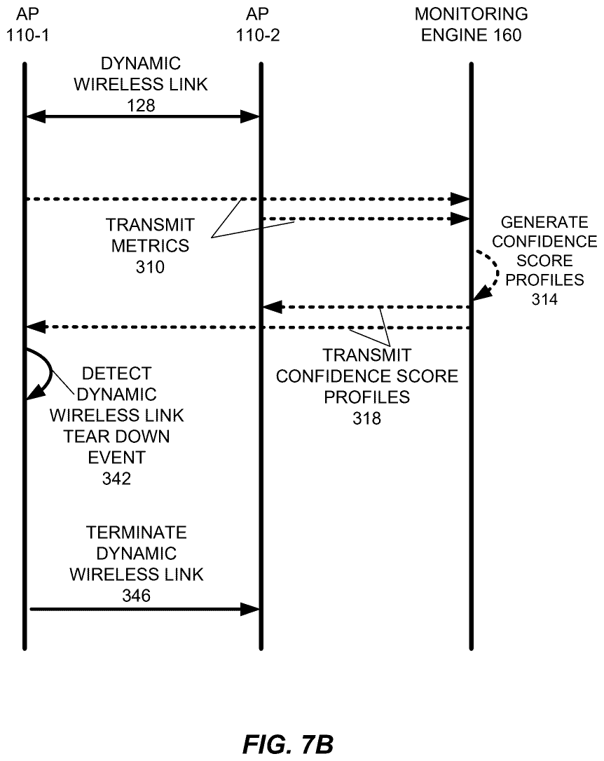

FIGS. 7A and 7B illustrate communications between some devices of a computer network according to some embodiments of the present inventive concepts. As can be seen in FIG. 7A, each of a first access point 110-1 and a second access point 110-2 may transmit metrics generated and/or obtained thereby to a monitoring engine 160 (operation 310 of FIG. 7A). Using the received metrics, the monitoring engine 160 may generate confidence score profiles for each of the access points 110 (operation 314) and may transmit to each access point 110 a set of confidence score profiles that includes a confidence score profile corresponding to the access point 110 receiving the set, as well as confidence score profiles corresponding to neighbor access points 110 in wireless communication range with the access point 110 that receives the set (operation 318). Subsequently to receiving a set, one of the access points 110 (e.g., the first access point 110-1) may detect an event has occurred that indicates a dynamic wireless link should be established to communicate at least some client device traffic handled by the access point 110-1 (operation 322). The first access point 110-1 detecting the event may then access the set of confidence score profiles and select a neighbor access point 110-2 based at least in part on the confidence score profile associated with the neighbor access point 110 (operation 324). The first access point 110-1 may then transmit a request to the selected neighbor access point 110-2 to establish a dynamic wireless link with the selected neighbor access point 110-2 (operation 326), and may establish the dynamic wireless link with the selected neighbor access point 110-2 (operation 330). Once the dynamic wireless link is established, at least some traffic received at the first access point 110-1 from client devices 120 wirelessly connected thereto may be directed to or communicated using the established wireless link to the selected neighbor access point 110-2 (operation 334), and may be forwarded by the selected neighbor access point 110-2 to a switch network (operation 338).

Referring next to FIG. 7B, it is assumed that a dynamic wireless link 128 is established between the first access point 110-1 and the second access point 110-2. After the establishment of the dynamic wireless link 128, the first and second access point 110-1, 110-2 may transmit metrics to the monitoring engine 160 (operation 310), which may generate confidence score profiles (operation 314), and transmit a set of confidence score profiles to each access point (operation 318) as discussed above with respect to FIG. 7A. The first access point 110-1 may receive a new set of confidence score profiles and/or may detect that the dynamic wireless link 128 is no longer required (e.g., the event or condition for which the dynamic wireless link 128 was established is no longer present), and thus may detect that the dynamic wireless link 128 may be torn down (operation 342 of FIG. 7B). In response, the first access point 110-1 may disconnect from the second access point 110-2 (operation 346).

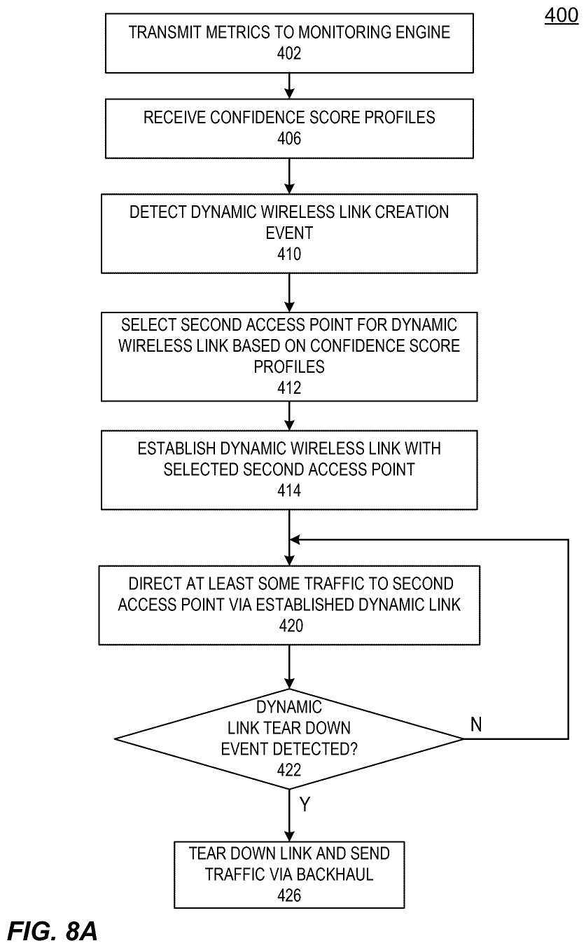

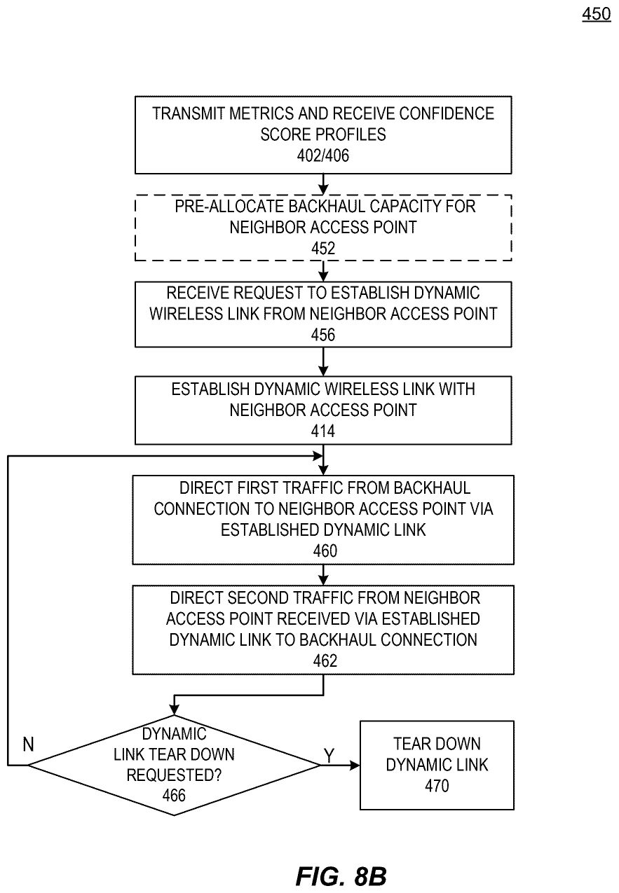

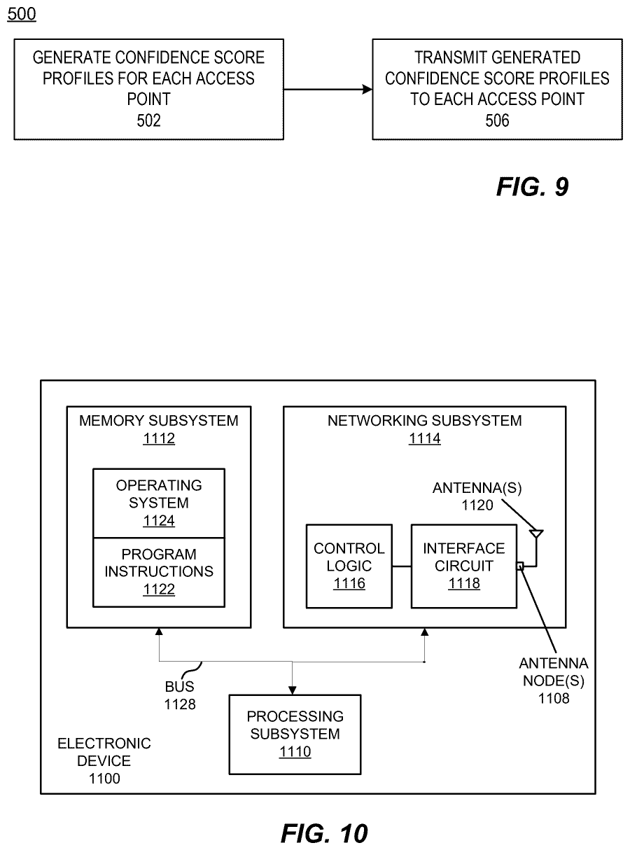

FIGS. 8A, 8B, and 9 are flow diagrams showing some operations of methods according to some embodiments of the present inventive concepts. Referring first to FIG. 8A, according to some embodiments, in a method 400, an access point 110 may transmit (e.g., periodically transmit) metrics to a monitoring engine 160 (block 402). In some embodiments, the metrics may include link utilization metrics and/or data indicative of usage of a wired backhaul link 132 between the transmitting access point 110 and a switch network 132. The metrics may include metrics that are averaged over a time period. The monitoring engine may generate confidence score profiles for each access point 110, and may communicate a set of confidence score profiles to the access point 110 (block 406). The set of confidence score profiles may include a confidence score profile for the access point 110 receiving the set and the set may include a confidence score profile for at least one neighbor access point 110 that is a neighbor to the access point 110 receiving the set. The at least one neighbor access point 110 may be in wireless communication range with the access point 110 receiving the set.

Subsequent to receiving the set of confidence score profiles, the access point 110 may detect an event indicating that a dynamic wireless link should be established (block 410). Some examples are shown in FIG. 3B (a newly-joining client device 120 may result in exceeding a capacity of the wired backhaul link 132), 4 (the wired backhaul link 132 becomes unusable), and 5 (an existing client device 120 wants to transmit or is transmitting high priority traffic that may exceed a capacity of the wired backhaul link 132). Based on detecting the event, and at least in part based on the confidence score profiles received from the monitoring engine, the access point 110 may select a neighbor access point 110 (block 412), and may establish a dynamic wireless link with the selected neighbor access point 110 (block 414), which may include transmitting a request to establish the dynamic wireless link to the selected neighbor access point 110. Once the dynamic wireless link is established, at least some traffic received at the access point 110 from client devices 120 wirelessly connected thereto may be directed to or communicated using the established wireless link to the selected neighbor access point 110 (block 420).

The access point 110 may then detect whether the event that warranted the dynamic wireless link has ended or been resolved, and/or an event has occurred indicating that the dynamic wireless link should be torn down (block 422). If so (“Y” branch from block 422), then the dynamic wireless link may be torn down and network traffic may be communicated via the wired backhaul link (block 426). If not (“N” branch from block 422), the access point 110 may continue to communicate traffic received from client devices 120 connected thereto to the selected neighbor access point 110.

Referring next to FIG. 8B, according to some embodiments, in a method 450, a first access point 110 may transmit (e.g., periodically transmit) metrics to a monitoring engine 160 and may receive from the monitoring engine 160 a set of confidence score profiles (block 402/406), which may be similar to blocks 402 and 406 discussed above with respect to FIG. 8A such that duplicate description thereof is omitted here in favor of the above. In some embodiments, and optionally, upon receipt of the set of confidence score profiles from the monitoring engine 160 the first access point 110 may allocate or reserve some capacity on a wired backhaul link 132 providing service thereto, with the capacity allocated or reserved for one or more neighbor (second) access points 110 that are in wireless communication range of the first access point 110 and have relatively low or poor confidence scores. The relatively low or poor confidence score of the neighbor access point 110 may indicate that the neighbor access point 110 may request that a dynamic wireless link be established with the first access point 110.

Subsequent to receiving the set of confidence score profiles (and in some embodiments, subsequent to allocating or reserving capacity), the first access point 110 may receive a request from a neighbor access point 110 that a dynamic wireless link be established between the neighbor access point 110 and the first access point 110 (block 456). Responsive to the request, the neighbor access point 110 and the first access point 110 may coordinate to establish the dynamic wireless link 128 (block 414).

Once the dynamic wireless link is established, at least some traffic may be received at the neighbor access point 110 from client devices 120 wirelessly connected thereto may be directed to or communicated using the established wireless link to the first access point 110, which may forward or direct the received traffic to the switch network 132 (block 460). At least some traffic may be received at the first access point 110 for client devices 120 wirelessly connected to the neighbor access point 110 and may be directed to or communicated using the established wireless link to the neighbor access point 110 (block 462).

The first access point 110 may then detect it has received a request from the neighbor access point 110 to tear down or close the dynamic wireless link, indicating the event that warranted the dynamic wireless link has ended or been resolved. If so (“Y” branch from block 466), then the dynamic wireless link may be torn down (block 470). If not (“N” branch from block 466), the first access point 110 may continue to communicate traffic to and from the neighbor access point 110 using the established dynamic wireless link 126. In some embodiments, the first access point 110 may instantiate a timer or other watchdog mechanism and tear down or close the established dynamic wireless link 126 if no traffic is received during a duration of the timer.

Referring next to FIG. 9, in some embodiments, a method 500 may include receiving, at a monitoring engine 160, metrics from one or more computing devices connected to a network (block 502). The computing devices may include access points 110, client devices 120, and/or switches 130. The monitoring engine 160 may generate a confidence score profile for each access point 110 in the network (block 506), and may transmit the generated confidence score profiles to each access point 110 (block 510), which may include transmitting to each access point 110 a set of confidence score profiles that includes a confidence score profile for that access point 110 and neighbor access points 110 in wireless communication range with the access point 110 receiving the set. The monitoring engine 160 may perform the operations shown in FIG. 9 periodically.

FIG. 10 is a block diagram illustrating an electronic device 1100 in accordance with some embodiments. The electronic device 1100 may be, for example, one or more computer networking devices 110/130 (e.g., access points 110, network switches 130), client devices 120, controller 170, network edge device 190, DHCP server 140 and/or DNS server 160 illustrated in FIG. 2. The electronic device 1100 includes a processing subsystem 1110, a memory subsystem 1112, and a networking subsystem 1114. Processing subsystem 1110 includes one or more devices configured to perform computational operations. Memory subsystem 1112 includes one or more devices for storing data and/or instructions. In some embodiments, the instructions may include an operating system and one or more program modules which may be executed by processing subsystem 1110.

Networking subsystem 1114 includes one or more devices configured to couple to and communicate on a wired and/or wireless network (i.e., to perform network operations), including: control logic 1116, an interface circuit 1118 and one or more antennas 1120 (or antenna elements). While FIG. 10 includes an antenna 1120, in some embodiments electronic device 1100 includes one or more nodes, such as nodes 1108, e.g., a connector, which can be coupled to one or more antennas 1120 that are external to the electronic device 1100. Thus, electronic device 1100 may or may not include the one or more antennas 1120. Networking subsystem 1114 includes at least a networking system based on the standards described in IEEE 802.11 (e.g., a Wi-Fi networking system).

Networking subsystem 1114 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1100 may use the mechanisms in networking subsystem 1114 for performing simple wireless communication between the electronic devices, e.g., transmitting frames and/or scanning for frames transmitted by other electronic devices.

Processing subsystem 1110, memory subsystem 1112, and networking subsystem 1114 are coupled together using bus 1128. Bus 1128 may include an electrical, optical, and/or electro-optical connection that the subsystems can use to communicate commands and data among one another.

Electronic device 1100 can be (or can be included in) any electronic device with at least one network interface. For example, electronic device 1100 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

The operations performed in the communication techniques according to embodiments of the present disclosure may be implemented in hardware or software, and in a wide variety of configurations and architectures. For example, at least some of the operations in the communication techniques may be implemented using program instructions 1122, operating system 1124 (such as a driver for interface circuit 1118) or in firmware in interface circuit 1118. Alternatively or additionally, at least some of the operations in the communication techniques may be implemented in a physical layer, such as hardware in interface circuit 1118.

Embodiments of the present disclosure have been described above with reference to the accompanying drawings, in which embodiments of the disclosure are shown. The inventive concepts may, however, be embodied in many different forms and should not be construed as limited to the embodiments set forth herein. Rather, these embodiments are provided so that this disclosure will be thorough and complete, and will fully convey the scope of the disclosure to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

What is claimed is:

1. A system, comprising:
a plurality of access points, each configured to communicate with one or more client devices; and
a monitoring engine, wherein the monitoring engine is configured to receive metric data periodically from the plurality of access points, and is further configured to generate confidence score profiles for each of the plurality of access points,
wherein a first access point of the plurality of access points is configured to:
receive a set of confidence score profiles from the monitoring engine;
detect occurrence of a dynamic wireless link creation event;
select, in response to the detecting of the occurrence of the dynamic wireless link creation event and based on the confidence score profiles, a second access point that is a neighbor of the first access point;
establish a dynamic wireless link between the first access point and the second access point; and
direct at least some network traffic to the second access point using the established dynamic wireless link.

2. The system of claim 1, wherein the detection of the occurrence of the dynamic wireless link comprises detection that a wired backhaul link between the first access point and a switch network is at or near capacity.

3. The system of claim 1, wherein the detection of the occurrence of the dynamic wireless link creation event comprises detection that a wired backhaul link between the first access point and a switch network is unusable.

4. The system of claim 1, wherein the detection of the occurrence of the dynamic wireless link creation event comprises detection that a client device in wireless communication with the first access point is sending or is attempting to send high priority data, or detection that a connection request has been received from a high-priority client device.

5. The system of claim 1, wherein the second access point of the plurality of access points is configured to: receive network traffic from a switch network destined for a client device in wireless communication with the first access point, and forward the network traffic to the first access point via the established dynamic wireless link.

6. The system of claim 1, wherein prior to establishment of the dynamic wireless link between the first access point and the second access point, the second access point is configured to allocate a portion of a capacity between the second access point and switch network for network traffic received from the first access point via the established dynamic wireless link.

7. The system of claim 1, wherein the first access point of the plurality of access points is configured to:
detect that a condition associated with the dynamic wireless link creation event has been resolved; and
in response to the detection that the condition has been resolved, tear down the dynamic wireless link.

8. The system of claim 1, wherein the set of confidence score profiles received by the first access point includes a first confidence score profile corresponding to the first access point and a second confidence score profile corresponding to the second access point.

9. The system of claim 8, wherein the set of confidence score profiles further includes a third confidence score profile corresponding to a third access point of the plurality of access points.

10. The system of claim 1, wherein each confidence score profile of the confidence score profiles indicates a determination of available capacity for a wired backhaul link between an access point of the plurality of access points respectively corresponding to the confidence score profile.

11. The system of claim 10, wherein the determination of the available capacity for the wired backhaul link is discretized into one or more levels based on a comparison of an available backhaul capacity with one or more predetermined threshold values.

12. An access point, comprising:
a processor; and
memory storing non-transitory instructions that, when executed by the processor, cause the processor to:
transmit metrics to a monitoring engine;
receive a set of confidence score profiles from the monitoring engine;
detect an occurrence of dynamic wireless link creation event; and
select a neighbor access point based at least in part on the set of confidence score profiles; and
establish a dynamic wireless link with the neighbor access point in response to the detected occurrence of the dynamic wireless link creation event.

13. The access point of claim 12, wherein the detection of the occurrence of the dynamic wireless link creation event comprises detection that a wired backhaul link between the access point and a switch network is at or near capacity.

14. The access point of claim 12, wherein the detection of the occurrence of the dynamic wireless link creation event comprises detection that a wired backhaul link between the access point and a switch network is unusable.

15. The access point of claim 12, wherein the detection of the occurrence of the dynamic wireless link creation event comprises detection that a client device in wireless communication with the access point is sending or is attempting to send high priority data.

16. A method comprising:
receiving, by a first access point, a set of confidence score profiles from a monitoring engine;
detecting, by the first access point, occurrence of a dynamic wireless link creation event;
selecting, by the first access point in response to the detecting of the occurrence of the dynamic wireless link creation event and based on the confidence score profiles, a second access point;
establishing a dynamic wireless link between the first access point and the second access point; and
directing, by the first access point, at least some network traffic received from a client device wirelessly connected with the first access point to the second access point using the established dynamic wireless link.

17. The method of claim 16, wherein the detecting of the occurrence of the dynamic wireless link comprises detecting that a wired backhaul link between the first access point and a switch network is at or near capacity.

18. The method of claim 16, wherein the detecting of the occurrence of the dynamic wireless link comprises detecting that a wired backhaul link between the first access point and a switch network is unusable.

19. The method of claim 16, wherein the detecting of the occurrence of the dynamic wireless link comprises detecting that a client device in wireless communication with the first access point is sending or is attempting to send high priority data.

20. The method of claim 16, wherein the set of confidence score profiles received by the first access point includes a first confidence score profile corresponding to the first access point and a second confidence score profile corresponding to the second access point.
